(19) United States
(12) Patent Application Publication
(10) Pub. No.: US 2021/0312529 A1
(43) Pub. Date: Oct. 7, 2021

(54) SYSTEMS AND METHODS FOR CONTROLLING UPDATES TO BOOKING DATA

(71) Applicants: AMADEUS S.A.S., Sophia Antipolis, Biot (FR); I:FAO GROUP GMBH, Frankfurt am Main (DE)

(72) Inventors: Maxence MALPARTY, Sophia Antipolis (FR); Nicolas GUILLON, Mouans-Sartoux (FR); Vincent LEON, Sophia Antipolis (FR); Roy GOLDSCHMITT, Waltham, MA (US); Fabrice MANTOAN, Waltham, MA (US); Deepak KOCHAR, Waltham, MA (US); Javier BUSQUIEL NIETO, Waltham, MA (US); Nicolas MAILLET, Waltham, MA (US); Ventsislav GEORGIEV, Frankfurt am Main (DE)

(21) Appl. No.: 17/267,081

(22) PCT Filed: Aug. 2, 2019
(86) PCT No.: PCT/EP2019/070857

§ 371 Date: Feb. 9, 2021

(30) Foreign Application Priority Data
Aug. 10, 2018 (FR) 1857434

(51) Int. Cl. G06Q 30/06; G06Q 20/02; G06Q 20/12; G06Q 10/10; G06N 20/00

(52) U.S. Cl. CPC G06Q 30/0637; G06Q 20/02; G06Q 20/12; G06Q 10/02; G06Q 10/1093; G06N 20/00; G06Q 30/0623

(57) ABSTRACT

A method of controlling updates to booking data corresponding to purchasable products includes, at an intermediate server connected with a booking server: obtaining and storing purchase initiation data including a transaction identifier and a client identifier; transmitting a request for product definitions to the booking server, according to the purchase initiation data; receiving and storing a product definition from the booking server in association with the purchase initiation data; generating an interactive message containing selectable product definition data, and transmitting the interactive message according to the client addressing identifier; receiving a product selection, responsive to selection of the product definition data in the interactive message at a client device; and generating a purchase instruction corresponding to the product definition and sending the purchase instruction to the booking server causing the booking server to update the booking data to reflect a purchase corresponding to the client addressing identifier.

### FIELD

The specification relates generally to processing of booking data corresponding to purchasable products, and specifically to systems and methods for controlling updates to such booking data.

### BACKGROUND

Some products (e.g. travel services such as airline, railway and bus tickets, hotel bookings and the like) can be purchased electronically via web sessions, in which a client computing device operated by a user seeking to purchase a product communicates with a web server hosting booking data. The above-mentioned web sessions typically expire after relatively short periods of time, which can lead to incomplete sessions and either or both of abandoned transactions and resource-consuming repetition of transaction initiations.

### SUMMARY

An aspect of the specification provides a method of controlling updates to a booking server maintaining booking data corresponding to purchasable products, the method comprising: at an intermediate server connected with the booking server, obtaining purchase initiation data including a transaction identifier and a client addressing identifier; storing the purchase initiation data in a repository at the intermediate server; at the intermediate server, generating and transmitting a request for product definitions to the booking server, according to the purchase initiation data; receiving a product definition from the booking server, and storing the product definition in the repository in association with the purchase initiation data; generating an interactive message containing selectable product definition data, and transmitting the interactive message according to the client addressing identifier; receiving a product selection at the intermediate server, responsive to selection of the product definition data in the interactive message at a client device corresponding to the client addressing identifier; and responsive to receiving the product selection, generating a purchase instruction corresponding to the product definition and sending the purchase instruction to the booking server causing the booking server to update the booking data to reflect a purchase corresponding to the client addressing identifier.

### BRIEF DESCRIPTIONS OF THE DRAWINGS

Embodiments are described with reference to the following figures, in which:

FIG. 1 depicts a system for controlling updates to booking data

FIGS. 2A and 2B depict certain internal components of an intermediate server and a detection server of the system of FIG. 1;

FIG. 3 depicts a method for controlling updates to booking data;

FIG. 4 depicts a method for detecting events initiating the performance of the method of FIG. 3;

FIG. 5 illustrates a performance of the method of FIG. 4;

FIG. 6A depicts another example event for initiating the performance of the method of FIG. 3;

FIGS. 6B, 7A and 7B depict example messages transmitted by the intermediate server during the performance of the method of FIG. 3;

FIG. 8 depicts a method of obtaining approvals for transactions initiated via the method of FIG. 3; and

FIG. 9 depict an example message transmitted by the intermediate server during the performance of the method of FIG. 8.

### DETAILED DESCRIPTION

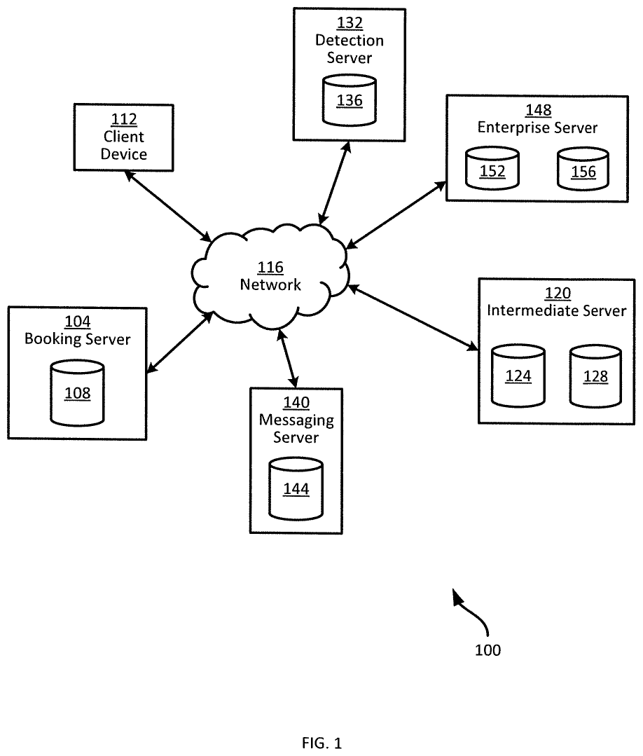

FIG. 1 depicts a system 100 for controlling updates to booking data corresponding to purchasable products. The system 100 includes a booking server 104 maintaining the above-mentioned booking data in a repository 108. The structure of the booking server 104 and the repository 108 are not particularly limited. For example, the repository 108 can be implemented as a plurality of databases or other suitable data storage structures. In general, the repository 108 contains data defining any of a variety of purchasable products (e.g. goods and/or services). In the discussion below, the purchasable products represented by the booking data include travel services, such as airline tickets (also referred to simply as flights). In other examples, various other travel services can be represented in the booking data in addition to or instead of flights. For example, the booking data in the repository 108 can define hotel reservations, railway tickets, bus tickets, taxicab reservations, and the like. A wide variety of other goods and/or services, generally referred to herein as products, will occur to those skilled in the art as being definable in the repository 108.

The booking data in the repository 108 also defines available inventory corresponding to the products mentioned above, as well as purchase records indicating products that have been purchased. In the context of purchasable flights, the repository 108 therefore defines not only which flights are available (e.g. by departure and arrival locations, dates and times, prices, and so on), but also how many seats on each of the above-mentioned flights remain available for purchase, and identifying data corresponding to seats that have been purchased (e.g. customer identifiers, payment information and the like). As noted above, the repository 108 can be implemented as a plurality of distinct databases in some embodiments, and inventory may therefore be maintained separately from product definitions or purchase records. The specific structure of the booking server 104 and the repository 108 is beyond the scope of the present disclosure, and is therefore not discussed in further detail herein.

As will now be apparent to those skilled in the art, purchases of the above-mentioned products require updating of the repository 108, for example to reflect changes in available inventory, to store additional purchase records, and the like. As will also be apparent, the booking server 104 or an associated server (not shown) may host a web-site through which products defined in the repository 108 may be purchased via interactions between the booking server 104 and a client computing device 112, such as a smartphone, desktop computer, or the like, over a network 116. The system 100 may include a plurality of client devices, but a single client device 112 is illustrated for simplicity. The network 116 can include any suitable combination of local and wide-area networks (e.g. including the Internet), implemented as any suitable combination of wired and/or wireless networks.

The above-mentioned web-based purchasing platform, however, may require that a transaction (i.e. the process of requesting product definitions from the server 104, selecting and completing purchase of one or more products) be completed within a continuous and relatively limited time period (e.g. five to ten minutes), beyond which an incomplete transaction is voided and must be restarted. In addition to the web-based platform, therefore, the system 100 includes an intermediate server 120 connected to the network 116 and configured to intermediate between the client device 112 and the booking server 104. Specifically, the intermediate server 120 implements functionality to retain at least a portion of a transaction's progress following interruptions of the transaction for greater periods of time than the relatively short time periods noted above (i.e. permitting transactions to be completed asynchronously). In addition, the intermediate server 120 can implement functionality enabling transactions to be initiated automatically or semi-automatically. In other words, the intermediate server 120 is configured to control the updating of booking data in the repository 108 to mitigate the incidence of voided transactions (which may lead to additional, identical transactions imposing additional computational load on the system 100, and particularly the booking server 104).

To that end, as will be discussed in greater detail below, the intermediate server 120 maintains a transaction repository 124 containing records each defining a pending or completed transaction. Based on interactions with the booking server 104, the client device 112 and optionally other computing devices also to be discussed herein, the intermediate server 120 is configured to update the above-mentioned pending transaction records and to apply corresponding updates to the booking data in the repository 108 under certain conditions.

The intermediate server 120 can also include an initiation queue 128, which although referred to herein as a queue, need not be specifically structured as a queue (e.g. a first-in-first-out or another suitable queue structure). More generally, the initiation queue 128 stores purchase initiation data obtained by the intermediate server 120 for initiating transactions corresponding to products represented in the booking data of the repository 108. The purchase initiation data received at the intermediate server 120 for storage in the queue 128 prior to further processing can be received, for example, from a detection server 132 connected to the network 116. The detection server 132 is configured to obtain and process data associated with the client device 112, to automatically detect purchase intent events (i.e. indications of desired transactions to purchase a product represented in the repository 108). The detection server 132 therefore maintains a raw data repository 136 configured to store the above-mentioned data associated with the client device 112 prior to processing to detect purchase intent events.

Further, the system 100 also includes a messaging server 140 maintaining a messaging repository 144. The messaging server 140 can implement any one or more of a variety of messaging technologies suitable for the exchange of data with the client device 112. In the examples discussed below, the messaging server 140 is an email server, and the messaging repository 144 therefore contains email messages corresponding to the client device 112 (or, more specifically, to an email account accessible from with the client device 112). The repository 144 may also contain email messages corresponding to other client devices (not shown), and is generally configured both to deliver inbound messages received from other entities (e.g. the intermediate server 120) to the client device 112, and to deliver outbound messages from the client device 112 to such other entities. The inbound and outbound messages, in some embodiments, need not be email messages, but can instead be commands to update the content of email messages or commands arising from interaction with email messages at the client device 112, as will be discussed in greater detail below.

The system 100 may also include an enterprise server 148, for example associated with an employer of an operator of the client device 112. The enterprise server 148 can maintain a profile database 152 containing profile records corresponding to the client device 112 (and any other client devices 112 in the system 100). Profile records can include identifying information corresponding to the operator of the client device 112 (e.g. name, mailing address, email address, payment information and the like), as well as policy indicators corresponding to the operator of the client device 112, such as permitted travel destinations or other conditions imposed upon product purchases by the operator, indications of whether such product purchases require approval by another entity, and the like. The enterprise server 148 may also maintain an enterprise expensing repository 156 configured to store records defining expenses for approval, or other requests subject to approval for management within the enterprise, as will be discussed in greater detail below. The expensing repository 156 may also, as will be discussed in greater detail below, track approval requirements and/or approval status for purchase transactions, and may include one or more approver identifiers corresponding to approving parties for purchase transactions initiated in association with the operator of the client device 112.

In other examples, the enterprise server 148 can be omitted. In such examples, the above-mentioned profile and/or policy data may be omitted, or stored in one or more other locations, such as at the client device 112 and/or the booking server 104. In some examples, the intermediate server 120 itself can store such profile and/or policy data.

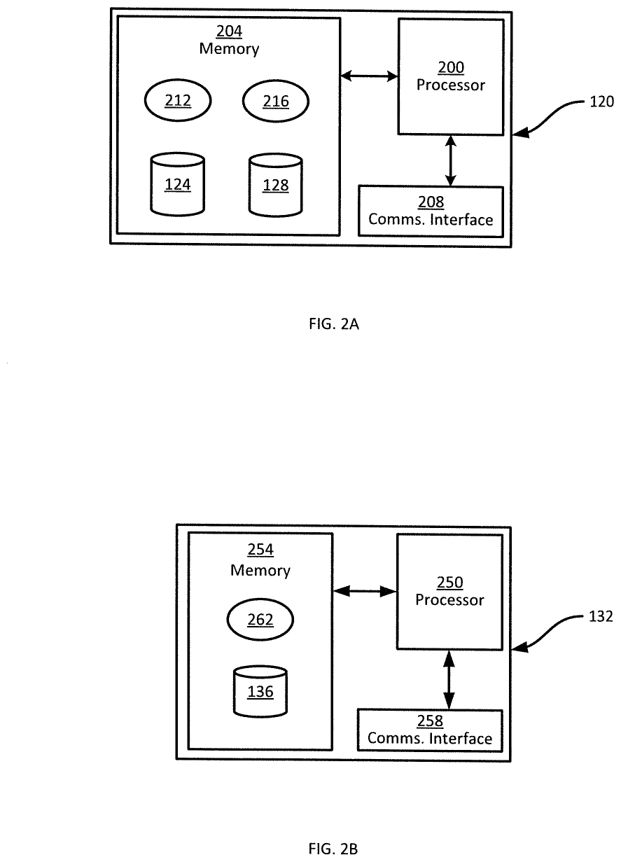

Turning to FIGS. 2A and 2B, before discussing the functionality of the system 100 in greater detail, certain components of the intermediate server 120 and the detection server 132 will be discussed in greater detail.

Referring in particular to FIG. 2A, the intermediate server 120 includes at least one processor 200, such as a central processing unit (CPU) or the like. The processor 200 is interconnected with a memory 204, implemented as a suitable non-transitory computer-readable medium (e.g. a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The processor 200 and the memory 204 are generally comprised of one or more integrated circuits (ICs).

The processor 200 is also interconnected with a communications interface 208, which enables the server 120 to communicate with the other computing devices of the system 100 via the network 116. The communications interface 208 therefore includes any necessary components (e.g. network interface controllers (NICs), radio units, and the like) to communicate via the network 116. The specific components of the communications interface 208 are selected based on upon the nature of the network 116. The intermediate server 120 can also include input and output devices connected to the processor 200, such as keyboards, mice, displays, and the like (not shown).

The components of the intermediate server 120 mentioned above can be deployed in a single enclosure, or in a distributed format. In some examples, therefore, the intermediate server 120 includes a plurality of processors, either sharing the memory 204 and communications interface 208, or each having distinct associated memories and communications interfaces.

The memory 204 stores the repository 124 and the queue 128 as introduced in connection with FIG. 1. The memory 204 also stores a plurality of computer-readable programming instructions, executable by the processor 200, in the form of various applications, including an orchestrator application 212 and a message generator application 216. As will be understood by those skilled in the art, the processor 200 executes the instructions of the applications 212 and 216 (and any other suitable applications) in order to perform various actions defined by the instructions contained therein. In the description below, the processor 200, and more generally the intermediate server 120, are said to be configured to perform those actions. It will be understood that they are so configured via the execution (by the processor 200) of the instructions of the applications stored in memory 204. Execution of the orchestrator application 212, as will be discussed below, configures the intermediate server 120 to retrieve purchase initiation data from the queue 128 (and optionally, to validate inbound initiation data prior to storing the data in the queue 128), and to interact with the booking server 104 to retrieve product definition data from the repository 108 and, under certain conditions, to apply updates to the repository 108.

The orchestrator application 212 can also implement one or more application programming interfaces (APIs) exposed to other computing devices via the network 116, for receiving various data relating to the transactions represented in the repository 124. Execution of the message generator application 216 configures the intermediate server 120 to generate and transmit messages to the client device 112 (e.g. via the messaging server 140) responsive to the activities implemented by the orchestrator application 212. In the present example, the message generator application 216 configures the intermediate server 120 to generate email messages. In particular, as will be seen below, the message generator application 216 configures the intermediate server 120 to generate email messages containing interactive elements, such as “actionable messages” for use within Microsoft™ Outlook email infrastructure.

Turning to FIG. 2B, the detection server 132 includes at least one processor 250, such as a central processing unit (CPU) or the like. The processor 250 is interconnected with a memory 254, implemented as a suitable non-transitory computer-readable medium (e.g. a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The processor 250 and the memory 254 are generally comprised of one or more integrated circuits (ICs).

The processor 250 is also interconnected with a communications interface 258, which enables the server 132 to communicate with the other computing devices of the system 100 via the network 116. The communications interface 258 therefore includes any necessary components (e.g. network interface controllers (NICs), radio units, and the like) to communicate via the network 116. The specific components of the communications interface 258 are selected based on upon the nature of the network 116. The detection server 132 can also include input and output devices connected to the processor 250, such as keyboards, mice, displays, and the like (not shown).

The components of the detection server 132 mentioned above can be deployed in a single enclosure, or in a distributed format. In some examples, therefore, the detection server 132 includes a plurality of processors, either sharing the memory 254 and communications interface 258, or each having distinct associated memories and communications interfaces.

The memory 254 stores the raw data repository 136 as introduced in connection with FIG. 1. The memory 254 also stores a plurality of computer-readable programming instructions, executable by the processor 250, in the form of various applications, including a purchase intent detection application 262 (also referred to simply as the detection application 262). The detection application 262, when executed by the processor 250, configures the processor 250 (and the server 132 more generally) to receive and store various types of data associated with the client device 112 in the repository 136, and to process such data to detect purchase intent events. Further, the server 132 is configured, via execution of the detection application 262, to generate purchase initiation data responsive to detecting a purchase intent event, for transmission to the intermediate server 120.

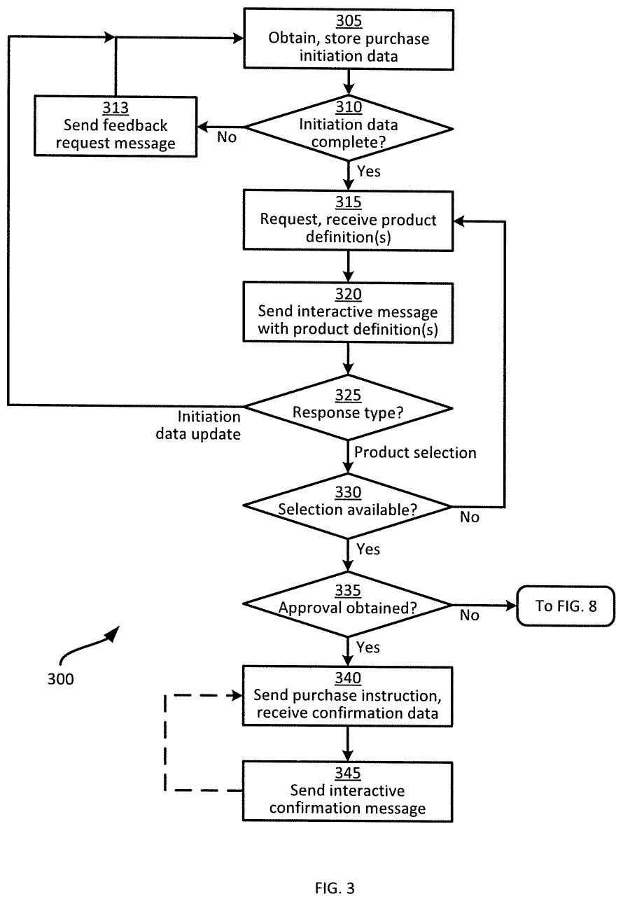

Turning now to FIG. 3, certain aspects of the operation of the system 100 will be described in greater detail. Specifically, FIG. 3 illustrates a method 300 of controlling updates to the booking server 104 (specifically, to the repository 108 of booking data). The method 300 will be described in conjunction with its performance within the system 100. In particular, the blocks of the method 300 are performed by intermediate server 120 via the execution of the orchestrator application 212 and the message generator application 216 by the processor 200. Additional aspects of the operation of the system 100 (particularly functionality implemented by the detection server 132) will be discussed later herein.

At block 305, the intermediate server is configured to obtain purchase initiation data and store the purchase initiation data in the queue 128. The purchase initiation data may be received from a variety of initiation data sources, including any of, or any combination of, the detection server 132, the booking server 104, and the intermediate server 120 itself (i.e. the purchase initiation data may be received via internal generation). Purchase initiation data includes at least a client addressing identifier suitable for directing messages to the client device 112 (e.g. an email address, telephone number, internal enterprise-assigned identifier such as a login identifier, or the like). Typically, the purchase initiation data also includes at least one of a predefined set of parameters defining one or more product characteristics. Examples of product characteristics, further examples of which will become apparent in the discussion below, include origin and destination locations for travel-related products such as flights.

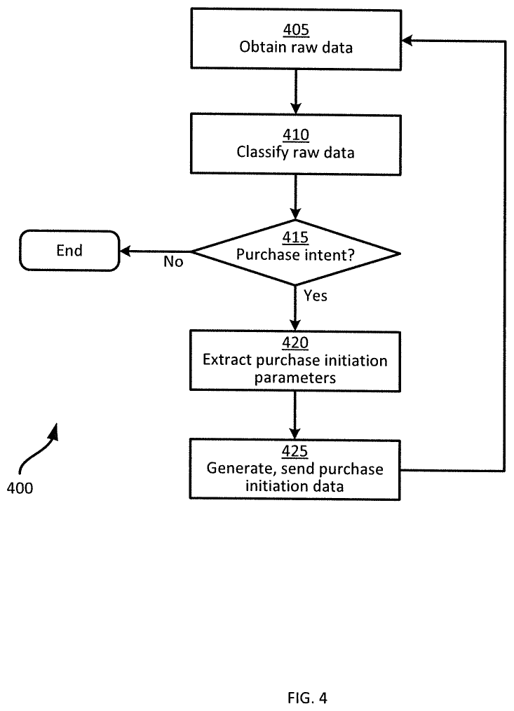

Purchase initiation data originates from a purchase intent event. A purchase intent event is an indication that the operator of the client device 112 intends, or likely intends, to purchase a product defined within the booking data of the repository 108. Various mechanisms are contemplated for the generation of purchase initiation data responsive to purchase intent events. In the present example, a purchase intent event is detected by the detection server 132 and purchase initiation data generated corresponding to the purchase intent event is generated by the detection server 132 for transmission to the intermediate server 120 and storage in the queue 128. Before continuing with the performance of method 300, the detection of purchase intent events and the generation of purchase initiation data will be discussed in greater detail with reference to FIG. 4.

FIG. 4 illustrates a method 400 of detecting purchase intent events and generating purchase initiation data responsive to such detection. The method 400 will be discussed in conjunction with its performance in the system 100, and in particular by the detection server 132. At block 405, the detection server 132 is configured to obtain raw data from the client device 112. The nature of the raw data is not particularly limited, and may include any one of, or any combination of, message data (e.g. email, instant messaging and the like), calendar data (e.g. strings of text defining events and corresponding dates), and the like. The raw data may be obtained via the execution of a monitoring application executed by the client device 112, configuring the client device 112 to transmit copies of messaging and/or calendar data to the detection server 132 for storage in the raw data repository 136. In other examples, the detection server 132 can operate a chatbot (e.g. an autonomous or semi-autonomous instant messaging service) configured to receive and respond to messages from the client device 112, and to store the content of such messages in the raw data repository 136.

At block 410, the detection server 132 is configured to retrieve an item of raw data from the repository 136 (e.g. an email message and/or email message thread, an instant messaging thread, a calendar event, or the like), and to classify the item of raw data. As will now be apparent, block 410 and the remaining blocks of the method 400 are performed for each item of raw data in the repository 136. The items of raw data in the repository 136 may be processed as discussed below sequentially, in parallel, or a combination thereof.

The detection server 132 is configured, at block 410, to classify the current item of raw data as indicative or not indicative of a purchase intent event. The output at block 410 may be a classification label (e.g. “purchase intent” or “no purchase intent”), a confidence level associated with a label (e.g. a 92% likelihood of purchase intent), or the like. Classification at block 410 includes two stages in the present example. In the first stage, the detection server 132 is configured to parse the item of raw data, for example to tokenize the text in the raw data item, discard less significant words, and the like. A variety of suitable parsing mechanisms (e.g. those available through various natural language processing suites) will occur to those skilled in the art. In the second stage, the detection server 132 is configured to apply a classification model to the parsed raw data to assign a classification to the raw data item. The classification model is based on any suitable machine learning model, examples of which include a support vector machine (SVM), a conditional random field, a neural network (e.g. a convolutional neural network or a deep neural network), and the like. The classification model is stored in the detection server 132 (e.g. as a component of the application 262), having previously been generated through a training process based on a training set of raw data items labelled with correct classifications (i.e. correctly indicating whether each raw data item in the training set corresponds, or does not correspond, to a purchase intent event).

At block 415, having classified the raw data item, the detection server 132 is configured to determine whether the raw data item indicates a purchase intent event. For example, the determination at block 415 can comprise comparing a confidence level generated at block 410 with a predefined threshold (e.g. 75%, although it will be apparent that thresholds below and above 75% may also be applied). When the confidence level exceeds the threshold, the determination at block 415 is affirmative, and when the confidence level does not exceed the threshold, the determination at block 415 is negative.

A negative determination at block 415 indicates that the raw data item is not indicative of an intent to purchase a product, and the performance of the method 400 ends. An affirmative determination at block 415, however, indicates that the raw data is indicative of an intent to purchase a product, and the detection server proceeds to block 420. At block 420, the detection server 132 is configured to extract purchase initiation parameters (which, as noted earlier, define one or more product characteristics) from the raw data item (specifically, from the parsed version thereof generated at block 410, in the present example).

The purchase initiation parameters are extracted at block 420 according to a set of parameter definitions applied to the raw data item via any suitable natural language processing (NLP) operation (or set thereof). The purchase initiation parameters include the above-mentioned client addressing identifier. Additional purchase initiation parameters may also be extracted at block 420. For example, for travel-related services such as flights, the application 262 can include definitions for origin and destination locations. Other examples of purchase initiation parameters for travel-related services include dates of travel (e.g. departure and return dates), travel reason (e.g. business or personal), preferred vendor (e.g. identifiers of airlines) and the like. As will be apparent, the method 400 can be deployed to detect purchase intent events associated with a wide variety of other goods and/or services (e.g. electronics, restaurant reservations, and the like). A simplified example of an origin location definition includes the presence of a string of text identifying a location in the raw data item, preceded by the word “from”. A wide variety of other parameter definitions will also occur to those skilled in the art. Detection of words identifying locations may be achieved, for example, by comparison of each word in the raw data item to a predefined location dictionary stored at the detection server 132.

The extraction of purchase initiation parameters at block 420 can include, in some examples, conversion of locations detected in the raw data item to airport codes. For example, responsive to detecting a location in the raw data item, the detection server 132 can be configured to obtain (e.g. internally or via request to an external conversion service, examples of which will occur to those skilled in the art) an airport identification code corresponding to the airport nearest to the location. Retrieval of the airport identification code may include converting the location to geographic coordinates (e.g. latitude and longitude) before identifying the nearest airport and obtaining the corresponding airport code.

At block 425, the detection server 132 is configured to generate and send a message containing the purchase initiation parameters to the intermediate server 120 (e.g. via a call to the above-mentioned API exposed by the intermediate server 120) for storage in the queue 128 and subsequent processing. The message sent at block 425 can include, for example, the purchase initiation data formatted according to JavaScript Object Notation (JSON), or any other suitable format (e.g. extensible markup language (XML) or the like).

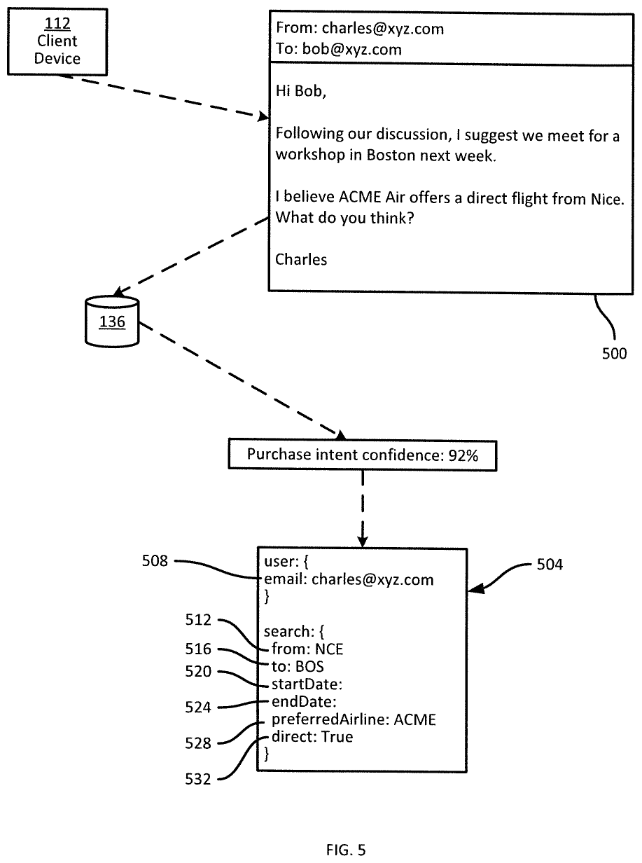

Turning to FIG. 5, a performance of the method 400 is illustrated in connection with a raw data item in the form of an email 500 obtained from the client device 112 and stored in the repository 136. As is evident from FIG. 5, the content of the email indicates an intent to travel, as well as locations (e.g. Boston and Nice). The classification at block 410 of the email 500 therefore results in a confidence level of 92%, indicating an elevated likelihood that the email 500 is indicative of a purchase intent event. In other examples, the raw data need not explicitly convey purchase intent, as in the example of FIG. 5. That is, the detection server 132 can be configured to identify raw data explicitly indicating purchase intent, and can also be configured to identify implicit or speculative purchase intent. For example, particularly in the case of the purchase of travel services, the detection server 132 may classify the raw data as indicative of purchase intent based on characteristics of the raw data such as a number of emails in a continuous thread, sentiments expressed (e.g. frustration, confusion or the like), and the like. Such characteristics may signal that travel for a face-to-face meeting is desirable, although the parties communicating have not expressed intent to travel. In some examples, the detection server 132 can implement such predictive classification as a secondary classification stage at block 410. That is, the detection server 132 can produce two confidence levels at block 410, the first indicating the likelihood that explicit purchase intent is expressed in the raw data, and the second indicating the likelihood that implicit or predicted purchase intent is expressed. Distinct thresholds may be applied to each confidence level at block 415 (e.g. explicit purchase intent may be required to satisfy a lower threshold than predicted purchase intent).

At block 420, the detection server 132 is configured to extract purchase initiation parameters for transmission in a suitable structured data object, such as a JSON object 504. The initiation parameters include, in the present example, a client addressing identifier 508 (e.g. an email address), an origin location 512, a destination location 516, a start (i.e. departure) date 520, an end (i.e. return) date 524, a preferred airline identifier 528, and a flight type preference 532 indicating preference for a direct flight. As will now be apparent, each value assigned to an initiation parameter in the data object 504 appears in the email 500. Certain initiation parameters, such as the start and end dates 520 and 524, are not populated as no dates are present in the email 500 to be extracted. In some examples, however, the detection server 132 is configured to extract such dates from header data or other metadata associated with the message. For instance, the detection server 132 can be configured to extract a start date equivalent to the date the email 500 was sent, incremented by a predetermined interval (e.g. one week).

Thus, returning to FIG. 3, at block 305 the intermediate server 120 is configured to receive, for example, the data object 504 from the detection server 132 and store the data object 504 in the queue 128. The intermediate server 120 can be configured, responsive to receiving purchase initiation data but before storing the purchase initiation data in the queue 128, to validate the purchase initiation data against one or more validation criteria. For example, purchase initiation data that does not include a client addressing identifier may be rejected (e.g. by returning an error to the source of the purchase initiation data), and discarded rather than stored in the queue 128.

Other mechanisms for obtaining purchase initiation data for storage in the queue 128 are also contemplated, in addition to or instead of the automated detection discussed above in connection with FIGS. 4 and 5. For example, the client device 112 can be configured to request the generation and transmission of purchase initiation data to the intermediate server 120. Specifically, the client device 112 can be configured to request a web page hosted by any one or more of the booking servers 104, the detection server 132, or the intermediate server 120 itself, and containing a product search interface.

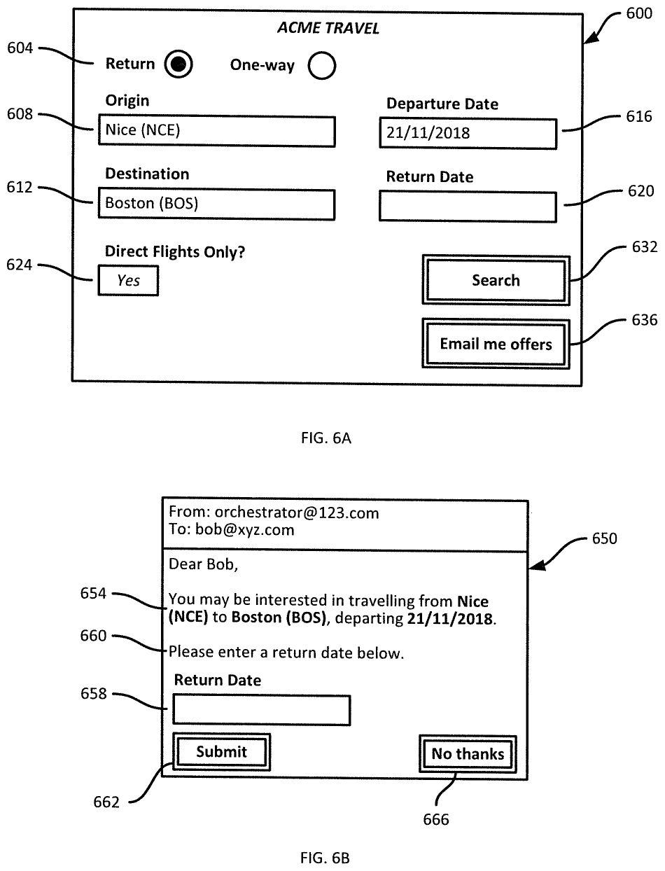

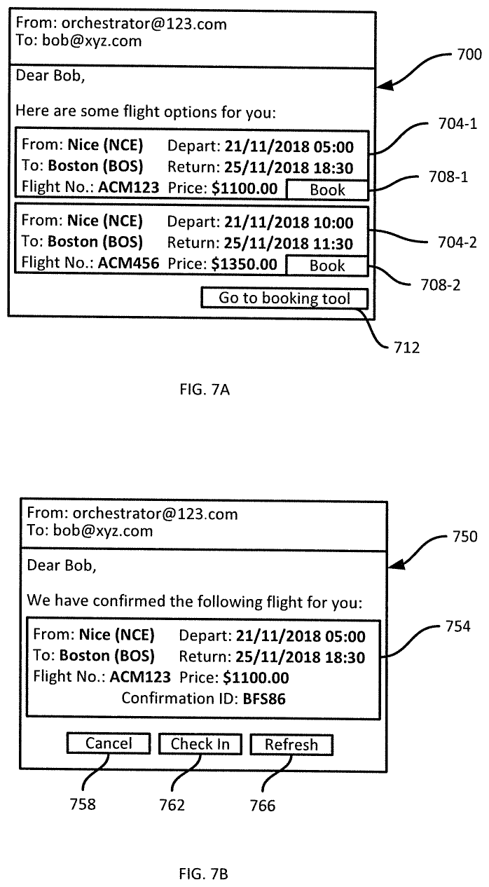

Turning to FIG. 6A, an example search interface 600 includes a plurality of selectable (e.g. via any suitable input assembly of the client device 112, such as a mouse, touch screen, keyboard or the like) input prompts each corresponding to a purchase initiation parameter. In the example shown, the interface 600 includes prompts corresponding to a set of seven search inputs. The prompts are generally referred to as “fields” in the discussion below, although it will be understood that a wide variety of formats (e.g. text fields, drop-down menus and the like) may be employed to collect search inputs. In particular, a first search field 604 includes a pair of radio buttons selectable (typically in mutually exclusive fashion, such that only one of the buttons may be marked as selected at a time) to indicate whether a return flight or a one-way flight is to be requested. Second and third search fields 608 and 612 are fields into which an origin location and a destination location, respectively, are provided. Fourth and fifth fields 616 and 620 are fields into which departure and return (if applicable, based on the selection associated with the field 604) dates, respectively, are provided. A sixth field 624 receives input data specifying whether the search is to be limited to direct flights only (“Yes”), or whether the search is also to return flights with one or more stops (“No”). As will be apparent to those skilled in the art, various other search fields can also be provided. For example, the search interface can include further fields for any one or more of an indication of whether to restrict the search to non-stop (i.e. direct) flights only, a class preference, an airline preference, and the like.

The interface 600 includes a selectable search element 632 for submitting a search query to the server 104 containing the inputs provided in the fields 600-628. As will now be apparent, selection of the element 632 typically initiates a time-limited transaction session with the booking server 104. In addition, however, the interface 600 includes a selectable element 636. Selection of the element 636, rather than initiating the above-mentioned transaction session, instructs the server hosting the interface 600 to generate and transmit purchase initiation data to the intermediate server 120 (e.g. via an API call, as mentioned previously) for storage in the queue 128. Where in the interface 600 does not include a prompt for a client addressing identifier such as an email address, selection of the element 636 can generate such a prompt. In other words, provision of the element 636 in the interface 600 adapts the interface 600 to initiate either a conventional web-based transaction session or a persistent transaction process maintained by the intermediate server 120.

Returning to FIG. 3, at block 310 the intermediate server 120 is configured to retrieve a set of purchase initiation data from the queue 128 and to determine whether the purchase initiation data is complete. The determination at block 310 includes determining whether a predetermined subset of the predefined set of parameters defining products in the booking data of the repository 108 are present in the purchase initiation data. The predetermined subset, in other words, is the minimum subset of parameters with which a transaction process is permitted to continue. The specific subset of parameters is not particularly limited, and varies at least with the type of product(s) represented in the repository 108. In the present example, in which the products are flights, the subset of parameters required for an affirmative determination at block 310 includes origin and destination locations, a departure date, and either a return date or an indication that a one-way flight is sought. Other examples of required subsets of parameters will also occur to those skilled in the art.

Continuing with the example initiation data shown in FIG. 6A and assuming that the return date is a required parameter to proceed with a transaction, the determination at block 310 is negative. The intermediate server 120 therefore proceeds to block 313, at which the intermediate server 120 is configured to generate and send an interactive message requesting additional purchase initiation data. Interactive messages, as referred to herein, are messages containing elements that are selectable at the client device 112, and that include data causing the client device 112 to transmit instructions to the intermediate server 120 when the elements are selected. The interactive messages may be, for example, Microsoft™ actionable messages, though various other forms of interactive messages will also occur to those skilled in the art. In general, the selectable elements of the interactive messages serve to prompt the operator of the client device 112 for further data associated with a pending transaction, and to relay the further data to the intermediate server 120 (e.g. via the messaging server 140, in the present example). When implemented using the above-mentioned actionable message technology, the selectable elements are also referred to as “adaptive cards”, “message cards”, or simply “cards”.

At block 313, the intermediate server 120 is configured to generate (via the generator application 216) and transmit an interactive message based on the purchase initiation data in the repository 124. In particular, the intermediate server 120 is configured to generate a message addressed according to the above-mentioned client addressing identifier (e.g. the email address “bob@xyz.com”). Further, the message generated at block 313 includes a selectable element for each purchase initiation parameter that is required to complete the purchase initiation data.

Table 1 below illustrates an example transaction record stored in the repository 124. As will be apparent in the discussion below, each transaction record in the repository 124 corresponds to a transaction initiated in connection with a particular client addressing identifier, and can be expanded with additional data according to the status of the transaction. Table 1 illustrates the transaction record following the performance of block 305. The record therefore contains only the purchase initiation data, which (as noted above) lacks a return date.

TABLE 1
Transaction Record (Initiation)

| Transaction ID | 6536758345 | |
|---|---|---|
| User | Email Address | bob@xyz.com |
| Search | From | NCE |
| | To | BOS |
| | Departure | Nov. 21, 2018 |
| | Return | |
| | Direct | True |

As seen above, in addition to the client addressing identifier and the purchase initiation parameters, the transaction record includes a transaction identifier, which is typically generated by the intermediate server 120. In other examples, the transaction identifier may be generated externally, and received with the purchase initiation data at block 305.

At block 313, the intermediate server 120 is configured to generate an interactive message containing a selectable element prompting for a return date. The content for the interactive message can be defined within the repository 124 itself, or in any other suitable data structure at the intermediate server 120. That is, the intermediate server stores renderable characteristics for the selectable elements employed in interactive messages (i.e. defining how the selectable elements are presented on a display of the client device 112), including field names and accompanying text (e.g. instruction a user what interaction is required with the selectable element), positional data, and graphics associated with the element (e.g. colours, images for display with the element, and the like). The repository 124, or another suitable data structure at the intermediate server 120, also specifies which parameters correspond to which selectable elements, as well as indications of which parameters are mandatory (i.e. which parameters are members of the above-mentioned subset). Further, each selectable element also includes computer-readable instructions causing the device rendering the selectable element (e.g. the client device 112) to initiate one or more instructions, such as API calls, to the intermediate server 120.

Turning to FIG. 6B, an example interactive message in the form of an actionable email 650 is illustrated, as displayed by the client device 112. As shown in FIG. 6B, the email 650 is addressed according to the client addressing identifier in the transaction record, and may also include a section summarizing the available purchase initiation data in the transaction record. Further, for each mandatory purchase initiation parameter (in the present example, simply the return date), the message 650 includes a selectable element 658 (e.g. a text field, a drop-down calendar for selection of a data, or the like), optionally with an accompanying description 660. The selectable element 658 accepts input data at the client device 112, in the present example representing a return date. The email 650 can include (e.g. as a parameter defining the element 658, or in any other suitable manner) data defining validation criteria to be met before selection of the element 662 is accepted. For example, the element 662 may become available for selection only when a correctly formatted date has been entered at the element 658.

In addition, the email 650 includes a selectable element 662 in the form of a “submit” button, selection of which causes the client device 112 to transmit an instruction to the intermediate server 120. In the present example, selection of the button 662 causes the client device 112 to transmit (e.g. via the same API call as employed by the detection server 132 to transmit purchase initiation data at block 425) a message containing at least a return date entered in the field defined by the element 658. The message may also contain all purchase initiation parameters represented in the email 650, and typically also includes the transaction identifier.

The email 650, in the illustrated example, also includes a further selectable element 666 in the form of a button indicating that the operator of the client device 112 does not intend to initiate a transaction. When the message 650 relates to a transaction record initiated via receipt of data from the detection server 132, selection of the element 666 indicates that the detection of a purchase intent event by the detection server 132 may have been incorrect. Responsive to selection of the element 666, the client device 112 is configured to transmit a message to the intermediate server 120 to clear the transaction record. The intermediate server 120 may also, following the receipt of a transaction clearing instruction, transmit a message to the detection server 132 containing the transaction record and an indication that the transaction record corresponds to a false detection of a purchase initiation event. As will now be apparent, the detection server 132 can collect such false detection records for further periodic training of the classification model employed at block 410. In some examples, the intermediate server 120 can be configured to transmit an interactive message at block 313 even when the purchase initiation data is complete, to request confirmation from the client device 112 that the user wishes to proceed with the transaction.

Following entry of a return date at the element 658 and selection of the submit element 662 at the client device 112, the client device 112 returns updated purchase initiation parameters to the intermediate server 120, as noted above. Thus, following another performance of block 305, the transaction record is updated as shown below in Table 2.

TABLE 2
Transaction Record (Feedback)

| Transaction ID | 6536758345 | |
|---|---|---|
| User | Email Address | bob@xyz.com |
| Search | From | NCE |
| | To | BOS |
| | Departure | Nov. 21, 2018 |
| | Return | Nov. 25, 2018 |
| | Direct | True |

In a further performance of block 310, the determination is affirmative, as the return date has been completed. The intermediate server thus proceeds to block 315, at which the intermediate server 120 is configured to transmit a request to the booking server 104 for product definitions corresponding to the purchase initiation data. The request transmitted at block 315, in other words, is a search for one or more products defined in the repository 108 matching the purchase initiation parameters stored in the transaction record of the repository 124. The formatting and transmission mechanism (e.g. transmission protocols and the like) are selected according to the capabilities and requirements of the booking server 104; a variety of suitable formats for the request at block 315 will occur to those skilled in the art. Responsive to the request, the intermediate server 120 is configured to receive one or more product definitions from the booking server 104, each defining a product (e.g. a flight in the present example) matching the purchase initiation parameters. The product definitions include product definition parameters including at least those in the purchase initiation data. The product definitions can include additional parameters, such as (in the example of flight products) airline identifiers, times of day for departure and return flights, prices, and the like.

Responsive to receiving the product definitions at block 315, the intermediate server 120 is configured to store the product definitions, which may also be referred to as offers, in the repository 124. In particular, the intermediate server 120 is configured to update the transaction record with the product definitions. Table 3, below, illustrates an updated version of the transaction record of Tables 1 and 2, with two product definitions stored herein.

TABLE 3
Updated Transaction Record (Product Definitions)

| Transaction ID | 6536758345 | |
|---|---|---|
| User | Email Address | bob@xyz.com |
| Search | From | NCE |
| | To | BOS |
| | Departure | Nov. 21, 2018 |
| | Return | Nov. 25, 2018 |
| | Direct | True |
| Offer | Offer ID | BFS86 |
| | Offer Description | . . . |
| Offer | Offer ID | GD875 |
| | Offer Description | . . . |

As shown above, each product definition (i.e. the data stored within an “Offer” block of the transaction record) includes a product definition identifier (or offer identifier), which may be assigned at the intermediate server 120 or received from the booking server 104. In addition, each product definition includes a product description, which is represented as a single filed for simplicity above, but can include any suitable number of fields, which may be structured in a format similar to the purchase initiation data (i.e. the “Search” block of the transaction record). Although two product definitions are illustrated above, the intermediate server 120 can receive a smaller or greater number of product definitions at block 315 in other examples. In some implementations, the intermediate server 120 can include in the request to the booking server 104 a maximum requested number of product definitions, e.g. to return the five (or any other suitable number) best matches to the purchase initiation data.

At block 320, the intermediate server 120 is configured to generate and send an interactive message (e.g. an actionable email, as mentioned above) containing selectable product definition data corresponding to the product definitions received at block 315. The selectable product definition data is encapsulated in, for example, one selectable element for each product definition, and includes both renderable data (e.g. some or all of the offer description) and non-renderable data (e.g. the transaction identifier, offer identifiers, and the like) that is included in the message but need not be displayed at the client device 112.

Turning to FIG. 7A, an example message 700 generated by the intermediate server 120 and displayed at the client device 112 is shown. As with the message 650 discussed above, the message 700 is delivered according to the client addressing identifier in the transaction record (in this instance, the email address bob@xyz.com). The message 700 includes first and second product definition elements 704-1 and 704-2, each containing at least a subset of the product definition parameters stored in the transaction record. The message 700 also includes, in association with each product definition element 704, a selectable element 708-1, 708-2 that is selectable at the client device 112 to generate and transmit a product selection to the intermediate server 120 (e.g. via the messaging server 140). The format of the message 700 as shown in FIG. 7A is illustrative only; as will be apparent to those skilled in the art, a wide variety of other formats can be employed to render the elements 704 and 708. For example, outgoing and return flights can be presented in separate elements.

The message 700 can also include, as shown in FIG. 7A, a selectable redirection element 712. Selection of the element 712 causes the client device 112 to transmit a redirection request to continue the transaction via a web-based transaction session, e.g. hosted by the booking server 104 itself. The redirection request can be transmitted directly to the booking server 104. In such examples, the message 700 includes a uniform resource locator (URL) or other network identifier corresponding to the element 712 and including parameters for transmission to the booking server 104 to retrieve a web page (such as that shown in FIG. 6A) for display at the client device 112 that renders the product definitions represented by the elements 704. In other examples, the redirection request can be transmitted to the intermediate server 120, which in response can retrieve (e.g. by request to the booking server 104) or generate a URL or other network identifier and return the network identifier to the client device 112 in a redirection command, causing the client device 112 to transmit a request to the booking server 104 containing the network identifier.

Returning to FIG. 3, at block 325 the intermediate server 120 is configured to await a response to the message sent at block 320. As will now be apparent, the response is typically not a return message of the same type as sent at block 320 (e.g. an email message, in the present example). Instead, the response may be an API call or other instruction generated by the client device 112 or the messaging server 140 according to the data contained in the message sent at block 320. As will also be apparent, the response received at block 325 need not closely follow the transmission of the message at block 320. That is, the transmission at block 320 and the response received at block 325 can be asynchronous.

When the response received at block 325 indicates an update to the purchase initiation data, the intermediate server returns to block 305 (as discussed above in connection with block 313). In some examples, the message sent at block 320 may permit the selection of revised purchase initiation parameters at the client device 112. In other examples, however, this functionality may be omitted, and the return to block 305 may therefore also be omitted.

When the response received at block 325 includes a product selection (e.g. an API call for initiating a purchase of one of the product definitions included in the message from block 320), the intermediate server 120 proceeds to block 330. At block 330, the intermediate server 120 is configured to verify whether the product corresponding to the product selection remains available for purchase. As noted above, the delivery of product definitions to the client device 112 and the receipt of product selections may be asynchronous, and sufficient time may therefore have elapsed between blocks 320 and 325 for the inventory represented in the repository 108 to have changed. At block 330, therefore, the intermediate server 120 is configured to transmit a request to the booking server 104 to determine whether the product selected in the response at block 325 is available for purchase. Various forms of request can be employed at block 330. For example, when the offer identifiers shown in Table 2 are received from the booking server 104 at block 315, the request can include the offer identifier corresponding to the selection received at block 325 (e.g. the offer ID “BFS86” if the response received at block 325 indicated a selection of the element 708-1 at the client device 112). When the offer identifier is assigned at the intermediate server 120 itself, and therefore is not stored in the repository 108, the request at block 330 can include a search request similar to that sent at block 315, following which the intermediate server 120 is configured to receive product definitions and determine whether any of the product definitions match the selected offer.

When the determination at block 330 is negative, indicating that the selected product definition cannot be purchased (e.g. because the corresponding product is no longer available), the intermediate server 120 returns to block 315 to obtain further product definitions, and the performance of blocks 320 and 325 are repeated. When the determination at block 330 is affirmative, the intermediate server 120 proceeds to block 335.

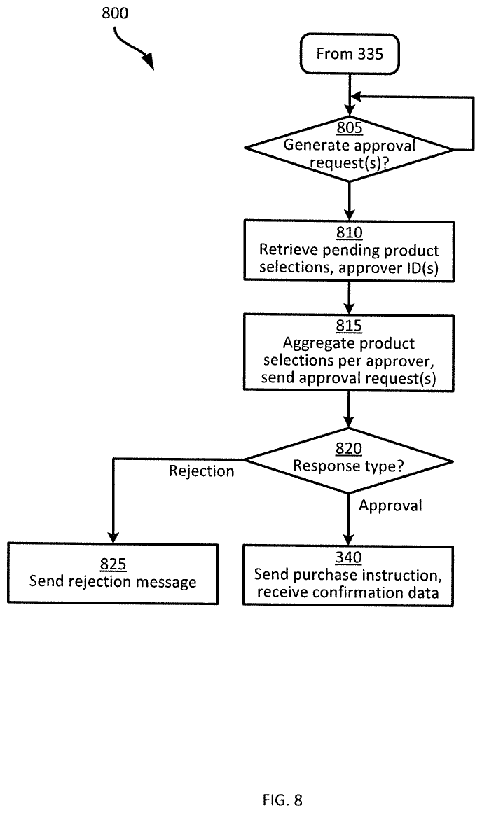

At block 335, the intermediate server 120 is configured to determine whether approval to initiate a purchase of the selected product has been obtained. In some examples, to be discussed in greater detail below, approval from a party other than that corresponding to the client addressing identifier may be required before finalizing any transactions (i.e. before sending a purchase instruction to the booking server 104). In other examples, block 335 may be omitted (effectively meaning that the determination at block 335 is always affirmative, as no approval is required). Additionally, in some examples, approval may be required for certain client addressing identifiers but not others, for certain types of purchase (e.g. certain goods or services may require approval, while others may be purchased without approval) but not others, or combinations of the above. The intermediate server 120 can therefore be configured to transmit a request to the enterprise server 148 with the client addressing identifier, and in response receive an indication (e.g. stored in the profile database 152) of whether approval is required before proceeding with the performance of method 300. The implementation of an approval process by the intermediate server 120 will be discussed below in connection with FIG. 8.

When the determination at block 335 is affirmative (or when block 335 is simply omitted), the intermediate server 120 is configured to proceed to block 340 and generate and send a purchase instruction to the booking server 104, causing the booking server 104 to update the booking data in the repository 108 to reflect a purchase of the product selected at block 325, corresponding to the client addressing identifier. The content and formatting of the purchase instruction sent at block 340 is selected according to the configuration of the booking server 104. The intermediate server 120 can be configured to retrieve data from either or both of the profile database 152 and the expense database 156 via request to the enterprise server 148 to generate the purchase instruction. For example, data retrieved from the enterprise server 148 can include a full legal name associated with the client addressing identifier, travel document data (e.g. a passport number), payment information (e.g. a credit card number) and the like.

Following transmission of the purchase instruction at block 340, the intermediate server 120 is configured to receive confirmation data from the booking server 104. The confirmation data can include, for example, a balance paid, a description of the purchased product (which may be identical to the description in the product definition previous discussed), and a confirmation identifier. The intermediate server 120 is configured, following receipt of the confirmation data, to store the confirmation data in the repository 124 and to then proceed to block 345. Table 4, below, illustrates the transaction record following completion of a transaction to purchase the product corresponding to the element 704-1 shown in FIG. 7A.

TABLE 4
Updated Transaction Record (Confirmation)

| Transaction ID | 6536758345 | |
|---|---|---|
| User | Email Address | bob@xyz.com |
| Search | From | NCE |
| | To | BOS |
| | Departure | Nov. 21, 2018 |
| | Return | Nov. 25, 2018 |
| Direct | True | |
| Confirmation | Confirmation ID | BFS86 |
| | Booking Description | . . . |

As shown above, the previously stored product definitions have been deleted from the transaction record and replaced with a confirmation block containing a confirmation identifier (e.g. a booking reference generated by the booking server 104) and one or more parameters defining the purchased product (the “booking description”). In other examples, the product definitions (i.e. the “offer” blocks discussed earlier) are retained in the transaction record, permitting subsequent bookings to be made without initiating a new transaction process at block 305 (e.g. in the event that the present booking is cancelled).

At block 345, the intermediate server 120 is configured to generate and transmit a further interactive message to the client device 112, according to the client addressing identifier, containing confirmation data such as the product definition and the above-mentioned confirmation identifier. Referring to FIG. 7B, an example confirmation message 750 is shown, in the form of a further actionable email. The message 750 includes a confirmation element 754 containing product definition data and the confirmation identifier shown in Table 4.

The confirmation message sent at block 345 can also include one or more selectable elements configured, upon selection at the client device 112, to initiate further updates to the booking data in the repository 108, reflecting modifications to the completed transaction. As shown in FIG. 7B, for example, the message 750 includes selectable elements 758, 762 and 766 configured to send instructions to the intermediate server 120 for, respectively, cancelling the transaction, initiating a check-in process, and refreshing the product definition data shown in the element 754. Selection of the cancellation element 758 at the client device 112 causes the client device 112 to transmit a cancellation command (e.g. an API call) to the intermediate server 120, which is then configured to send a cancellation instruction to the booking server 104, containing at least the confirmation identifier shown above. The cancellation instruction causes the booking server 104 to update the repository 108 to remove an indication that the relevant product has been purchased by the user associated with the client addressing identifier. The check-in instruction can cause the intermediate server 120 to redirect the client device 112 to a check-in URL hosted by the booking server 104, while the refresh instruction can cause the intermediate server 120 to retrieve an updated product definition from the booking server 104 (e.g. reflecting any scheduling changes for the flight shown in FIG. 7B) and generate a further confirmation message containing the updated product definition.

More generally, various modifications may be applied to the transaction following confirmation, as illustrated by the dashed line returning from block 345 to block 340. Other examples of actions that can be performed in connection with a completed transaction include the initiation of an additional transaction for a related product (e.g. a hotel reservation or other ancillary good and/or service), via the generation of additional purchase initiation data (initiating another performance of the method 300).

Turning now to FIG. 8, a method 800 of obtaining approval data for pending transactions is illustrated. The performance of the method 800 will be described in conjunction with its performance within the system 100, and in particular by the intermediate server 120 to obtain approvals for transactions initiated via performance of the method 300. In other examples, however, the method 800 can be deployed independently of the method 300, to obtain approvals for transactions initiated via other mechanisms.

At block 805, the intermediate server 120 is configured to determine whether to generate approval request messages, for example associated with pending transactions having reached block 335 of the method 300. The determination at block 805 can be based, for example, on a predetermined schedule. For instance, the intermediate server 120 can be configured to perform the method 800 once daily, at a predetermined time of day. In other examples, a distinct computing device can be configured to periodically instruct the intermediate server 120 (e.g. via the network 116) to perform the method 800. In such examples, the determination at block 805 is simply a determination of whether an instruction to obtain approvals has been received.

When the determination at block 805 is negative, the intermediate server 120 repeats the determination. As will be apparent, one or more instances of the method 300 can be performed in parallel with the method 800, and thus while awaiting an affirmative determination at block 805, the intermediate server 120 may generate and update transaction records as discussed above.

When the determination at block 805 is affirmative, the intermediate server 120 proceeds to block 810, to retrieve pending transactions in which product selections have been made (e.g. by client devices such as the client device 112) and for which approval is pending (i.e. for which an affirmative determination at block 335 has not yet been made). Table 5 illustrates the transaction record as shown in Table 3, with an additional status field associated with the offer identifier “BFS86” inserted into the transaction record following a product selection received at block 325.

TABLE 5
Updated Transaction Record (Approval Pending)

| Transaction ID | 6536758345 | |
|---|---|---|
| User | Email Address | bob@xyz.com |
| Search | From | NCE |
| | To | BOS |
| | Departure | Nov. 21, 2018 |
| | Return | Nov. 25, 2018 |
| | Direct | True |
| Offer | Offer ID | BFS86 |
| | Offer Description | . . . |
| Status | Approval pending | |
| Offer | Offer ID | GD875 |
| | Offer Description | . . . |

In particular, as seen above, the selected product definition includes a status indicator stating that approval has not yet been obtained to proceed with the transaction (i.e. to block 340). At block 810, the intermediate server 120 is configured to retrieve each transaction record having a status indicator stating that approval is pending. As will now be apparent, a plurality of transaction records may be stored in the repository 124 at any given time, and a plurality of those transaction records may have an approval pending status.

At block 810, the intermediate server 120 is also configured to retrieve approver identifiers (e.g. approver addressing identifiers, such as email addresses) corresponding to each pending transaction identified in the repository 124. Retrieval of approver identifiers can include, for example, transmitting a request to the enterprise server 148 containing the client addressing identifiers associated with each pending transaction. The enterprise server 148 can contain, for example in the expense database 156, approver identifiers corresponding to each client addressing identifier.

At block 815, the intermediate server 120 is configured, for each approver identifier retrieved at block 810, to aggregate the pending transactions retrieved at block 810 for which approval is required from the approver identifier. For example, a given approver identifier (e.g. “sara@xyz.com”) may be received from the enterprise server 148 as the approver identifier corresponding to the pending transaction shown in Table 5, as well as another pending transaction associated with the client addressing identifier “alice@xyz.com”. Thus, at block 815 the intermediate server 120 is configured to generate an aggregated interactive message addressed to the approver (in the illustrated example, sara@xyz.com). The aggregated message includes selectable approval elements for each pending transaction corresponding to the approver identifier.

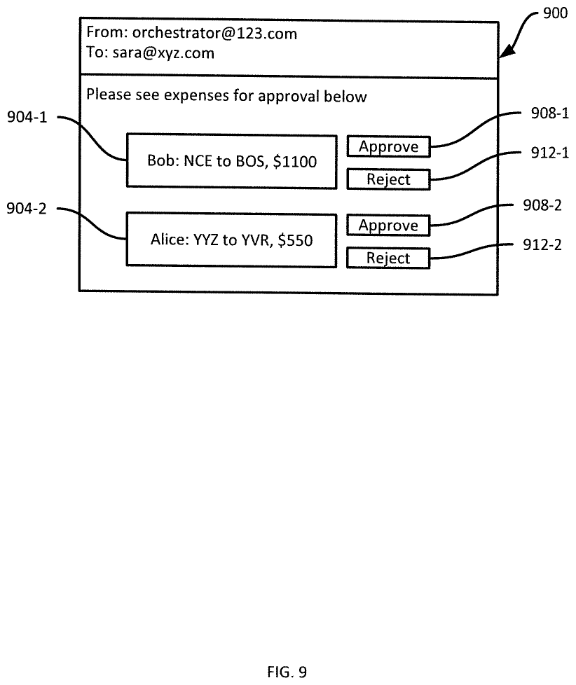

Referring to FIG. 9, an example aggregated approval request message 900 is shown, in the form of an actionable email. The message 900 includes product definition elements 904-1, 904-2 for each of the pending transactions identified at block 810, including at least a subset of the product definition data associated with those pending transactions. In addition, the message 900 includes selectable approval elements 908-1, 908-2 and selectable rejection elements 912-1, 912-2. Selection of an approval element 908 causes a client device associated with the approver identifier to transmit an approval instruction containing the relevant transaction identifier to the intermediate server 120 (e.g. as an API call). Responsive to receiving the approval instruction at block 820, the intermediate server 120 is configured to update the corresponding transaction record to indicate an approved status, and to then proceed to block 340 as discussed above.

Responsive to receiving a rejection instruction at block 820, on the other hand, the intermediate server can be configured to delete the transaction record, or to update the transaction record to indicate a rejected status. The intermediate server 120 can also be configured, at block 825, to generate and transmit a rejection message to the client addressing identifier associated with the rejected transaction, advising the recipient that the requested purchase has been rejected. The rejection message may also include a comment provided in the response from the approver received at block 820 (e.g. in an interactive field of the message 900, not shown). As will now be apparent, following a rejection the performance of them method 300 for the rejected transaction does not proceed to block 340, and no updates are therefore made to the booking data in the repository 108.

Variations to the above systems and methods are contemplated. In some examples, the generation and transmission of interactive messages as discussed above can be performed by updating previously transmitted messages rather than generating new messages. For example, following a negative determination at block 330 and return to blocks 315 and 320, the intermediate server 120 can be configured to transmit an instruction to the messaging server 140 to update the content of the message sent at the previous instance of block 320, for example to replace previous product definitions with current product definitions. To that end, messages sent at block 320 can be assigned message identifiers maintained in the transaction record and at the messaging server 140, and permitting the intermediate server 120 to instruct the messaging server 140 to retrieve and modify a previous message to insert updated selectable elements (such as product definitions) therein. In some examples, a combination of the above approaches can be implemented, in which certain messages (e.g. confirmation messages) are generated as new messages, while others (e.g. messages containing offers) are transmitted as updates to previous messages, when a previous message is available for the same transaction.

Although the client device input data discussed above in connection with the method 300 is described as being received from the client device 112 associated with the client addressing identifier, in other examples the selections (e.g. product selections received at block 325) may be received from a distinct client device associated with a different addressing identifier. For example, the message 700 may be forwarded to a distinct email address associated with another client device, and the product selection discussed above may be received from that other client device. It will be understood, however, that the product selection remains associated with the client identifier “bob@xyz.com”, and subsequent messages are delivered to the same client identifier regardless of the origin of the selections. In other words, portions of the transaction may be delegated (e.g. within an organization) without affecting the client identifier with which the transaction is associated.

In further variations, the approval mechanism described above, when applied to purchases initiated via the performance of the method 300, can be invoked following block 340 rather than block 330. That is, in such examples block 335 is performed after the purchase instruction is transmitted and confirmation data is received at block 340, but before a confirmation message is sent to the client device 112 at block 345. In these examples, as will now be apparent, if approval is not granted at block 820, further updates may be required to the repository 108 to reverse the transaction confirmed at block 340. Thus, the server 120 may be configured to transmit a cancellation instruction when a rejection is received at block 820.

The scope of the claims should not be limited by the embodiments set forth in the above examples, but should be given the broadest interpretation consistent with the description as a whole.

1. A method of controlling updates to a booking server maintaining booking data corresponding to purchasable products, the method comprising:
at an intermediate server connected with the booking server, obtaining purchase initiation data including a transaction identifier and a client addressing identifier;
storing the purchase initiation data at the intermediate server;
at the intermediate server, generating and transmitting a request for product definitions to the booking server, according to the purchase initiation data;
receiving a product definition from the booking server, and storing the product definition in association with the purchase initiation data;
generating an interactive message containing selectable product definition data, and transmitting the interactive message according to the client addressing identifier;
receiving a product selection at the intermediate server, responsive to selection of the product definition data in the interactive message at a client device corresponding to the client addressing identifier; and
responsive to receiving the product selection, generating a purchase instruction corresponding to the product definition and sending the purchase instruction to the booking server causing the booking server to update the booking data to reflect a purchase corresponding to the client addressing identifier.

2. The method of claim 1, further comprising:
prior to storing the purchase initiation data, validating the purchase initiation data.

3. The method of claim 1, wherein obtaining the purchase initiation data comprises:
receiving the purchase initiation data at the intermediate server from the booking server.

4. The method of claim 1, wherein obtaining the purchase initiation data comprises:
receiving the purchase initiation data from a detection server.

5. The method of claim 1, further comprising, at the detection server:
receiving raw input data from the client device;
classifying the raw input data to determine whether the raw input data indicates a purchase intent event;
when the classification indicates a purchase intent event, extracting purchase initiation parameters from the raw input data; and
transmitting the purchase initiation parameters to the intermediate server.

6. The method of claim 5, wherein the raw input data includes at least one of messaging data and calendar data.

7. The method of claim 1, wherein the selectable product definition data contains command generation data causing the client device, responsive to the selection of the product definition data, to generate a command containing the product selection for transmission to the intermediate server.

8. The method of claim 1, further comprising, at the intermediate server:
prior to generating and transmitting the request for product definitions, determining whether the purchase initiation data contains a minimum subset of purchase initiation parameters; and
when the determination is negative, generating a feedback message containing a prompt for at least one of the minimum subset, for transmission to the client device.

9. The method of claim 1, further comprising:
retrieving an approval addressing identifier;
generating and transmitting an approval request message according to the approval addressing identifier, the approval request message containing a selectable approval element corresponding to the product selection; and
receiving a selection of the approval element.

10. The method of claim 9, wherein generating the approval request message further comprises:
retrieving an additional product selection corresponding to the approval addressing identifier; and
generating an aggregated request message containing the selectable approval element and an additional selectable approval element corresponding to the additional product selection.

11. A system for controlling updates to a booking server maintaining booking data corresponding to purchasable products, the system comprising:
an intermediate server connected with the booking server and configured to:
obtain purchase initiation data including a transaction identifier and a client addressing identifier;
store the purchase initiation data;
generate and transmit a request for product definitions to the booking server, according to the purchase initiation data;
receive a product definition from the booking server, and store the product definition in association with the purchase initiation data;
generate an interactive message containing selectable product definition data, and transmit the interactive message according to the client addressing identifier;
receive a product selection at the intermediate server, responsive to selection of the product definition data in the interactive message at a client device corresponding to the client addressing identifier; and
responsive to receiving the product selection, generate a purchase instruction corresponding to the product definition and send the purchase instruction to the booking server causing the booking server to update the booking data to reflect a purchase corresponding to the client addressing identifier.

12. The system of claim 11, wherein the intermediate server is further configured, prior to storing the purchase initiation data, to validate the purchase initiation data.

13. The system of claim 11, wherein the intermediate server is further configured to obtain the purchase initiation data by receiving the purchase initiation data from the booking server.

14. The system of claim 11, further comprising:
a detection server;
wherein the intermediate server is configured to obtain the purchase initiation data by receiving the purchase initiation data from the detection server.

15. The system of claim 14, wherein the detection server is configured to:
receive raw input data from the client device;
classify the raw input data to determine whether the raw input data indicates a purchase intent event;
when the classification indicates a purchase intent event, extract purchase initiation parameters from the raw input data; and
transmit the purchase initiation parameters to the intermediate server.

16. The system of claim 15, wherein the raw input data includes at least one of messaging data and calendar data.

17. The system of claim 11, wherein the selectable product definition data contains command generation data causing the client device, responsive to the selection of the product definition data, to generate a command containing the product selection for transmission to the intermediate server.

18. The system of claim 11, wherein the intermediate server is further configured to:
prior to generating and transmitting the request for product definitions, determine whether the purchase initiation data contains a minimum subset of purchase initiation parameters; and
when the determination is negative, generate a feedback message containing a prompt for at least one of the minimum subset, for transmission to the client device.

19. The system of claim 11, wherein the intermediate server is further configured to:
retrieve an approval addressing identifier;
generate and transmit an approval request message according to the approval addressing identifier, the approval request message containing a selectable approval element corresponding to the product selection; and
receive a selection of the approval element.

20. The system of claim 19, wherein the intermediate server is further configured to generate the approval request message by:
retrieving an additional product selection corresponding to the approval addressing identifier; and
generating an aggregated request message containing the selectable approval element and an additional selectable approval element corresponding to the additional product selection.
